(19) United States
(12) Patent Application Publication
(10) Pub. No.: US 2005/0253018 A1
(43) Pub. Date: Nov. 17, 2005

(54) Magnetic grounding-regenerating system for reducing in flight Jet Lag stress

(76) Inventor: Riach George JR., Cypress, CA (US)

Correspondence Address: ORUM & ROTH, 53 W. JACKSON BLVD, CHICAGO, IL, 60604, US

(21) Appl. No.: 10/843,238

(22) Filed: May 11, 2004

(51) Int. Cl. B64D 11/00

(52) U.S. Cl. 244/118.5

(57) ABSTRACT

A specifically designed and gaussed bipolar magnetic flexible rubberized material having both a north and south, top and bottom energized field, may be incased or housed in aluminum or plastic, where the opposite magnetic fields are separated so the north polarity of said field is always against the magnetized floor runner and bottom of the shoe, socked foot or bare foot, and the south side of the magnetized material is facing downward, away from the foot against the aisle flooring, above or below the air craft carpeting so as to become a permanent part thereof. The magnetic material may also be placed in or built into an insulated container for housing human organs under transport or in storage prior to transplantation.

### FIELD OF THE INVENTION

Background of the Invention

The present invention relates to a method and apparatus for helping to ground passengers during air flight above the surface of the earth, and more particularly to provide a magnetic field about a user via individual magnets placed proximate the user's body and/or in a aisle runner below or above the feet, having a bipolar magnetic north side against the bottom of the shoe or feet that will cause a negative ion natural bio-magnetic DNA molecular effect within the electro-chemical fluids of the body to help reduce Jet Lag and flight stress. The method further includes magnetic features so as to cause a stronger than earth's magnetic field to be present above or below the feet while in flight. Further discussion of magnetic field effects and therapy is made in applicant's U.S. Pat. No. 5,389,981 incorporated herein by reference.

### SUMMARY OF THE INVENTION

Problems and difficulties occur in providing a simple, natural, uncomplicated means of helping reduce the body in air flight from becoming much more positive, than negative as if on the earth's surface. During air flight, the entire body above the surface of the earth becomes predominately positive, and under ordinary in flight conditions acclimates to dehydration, resulting in more positive ions than desired negative ions within the fluids of the body. Desired negative ions within the fluids of the body retain, gain, maintain and sustain a constant or inconstant current flow having a regenerating or degenerating effect on the DNA molecular electro-magnetic-bio-magnetic, genetical DNA biological mass as to extensive astronautical travel in outer space.

The primary object of the present invention is to provide a new method and apparatus that employs an in flight magnetic north or negative ion arrangement of magnetically housed aisle runners below and above the feet as a permanent foundation for in flight passengers and outer space astronauts to help reduce in flight degeneration before, during and after the flight.

In flight degeneration, particularly when influenced by alcohol given or sold to passenger in flight, further dehydrates the body in some passengers, Jet Lag may turn into Jet Lag Rage, associated directly and indirectly with the body becoming more and more dehydrated under long durations of in flight travel. A helpful solution to this problem is the magnetic aisle runner which helps plug the in flight passenger into the magnetic north radiation which in turn helps polarize the entire body more uniformly as if grounded to earth.

In flight degeneration of human tissue, separate from a living body, is also a problem. Organs being transported for transplant may similarly be protected from stress and degeneration by their packaging for transport proximate a north magnetic field.

In flight Jet Lag stress can further be reduced by having a magnetic aisle runner throughout the floor of the air craft where a flexible rubber like material or plastic incased ferrite material, housing the positive south side towards the floor of the air craft, and the north or negative side towards the bottom of the shoe, sock or bare feet to acquire the desired results, more negative ions being released from the water in the blood directly into the oxygen carrying energy cells of the electro-chemical body in flight.

It is another object of the present invention to provide a method and apparatus of helping to naturally increase the flow of blood within the flight passengers making dissolved oxygen more bio-available to the entire body when literally in flight, being plugged into a stronger than earth's normal magnetic field as if on the surface of the earth negative magnetic field.

It is another object of this invention to provide an apparatus of this said kind and type that is simple in structure, has no moving parts, making it maintenance free over the life span of the air craft, easy to install and retains a stronger than earth's normal magnetic field influence.

In the event of fear, guilt, ignorance and superstition, it is still another object of this invention to give the passenger the freedom of choice as to in flight magnetic field use, by arranging the subject north side of the magnetic apparatus to the flooring in such a structural way as to avoid direct use by any particular in flight passenger.

It is another object of the present invention to provide a device that is relatively inexpensive to manufacture and install to maintain the natural and normal free wireless magnetic radiation from which all life is extended from the fundamental and basic laws of electric nature.

### BRIEF DESCRIPTION OF THE FIGURES

FIG. 1 is one embodiment of the present invention.

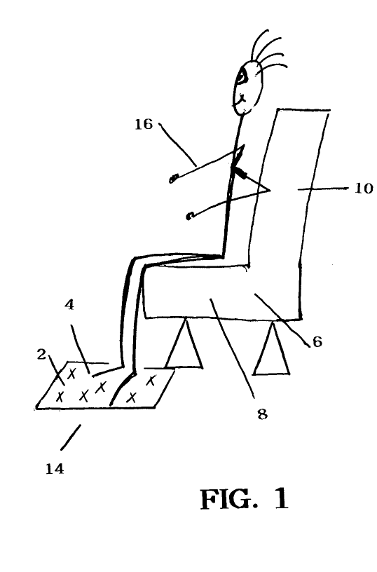

FIG. 2 is a first alternative embodiment to the present invention.

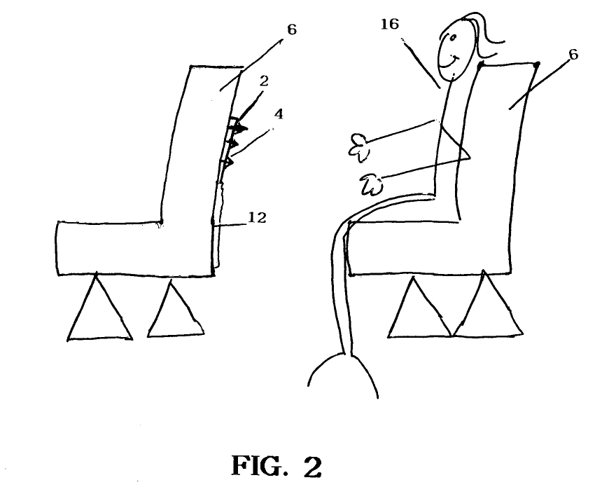

FIG. 3 is a second alternative embodiment to the present invention.

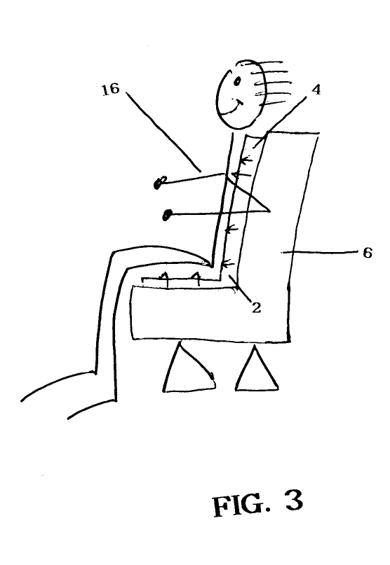

FIG. 4 is a third alternative embodiment to the present invention.

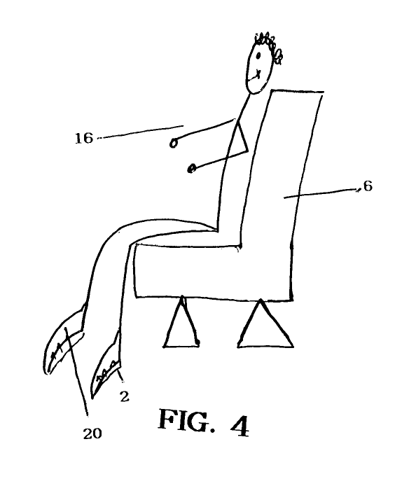

FIG. 5 is a fourth alternative embodiment to the present invention.

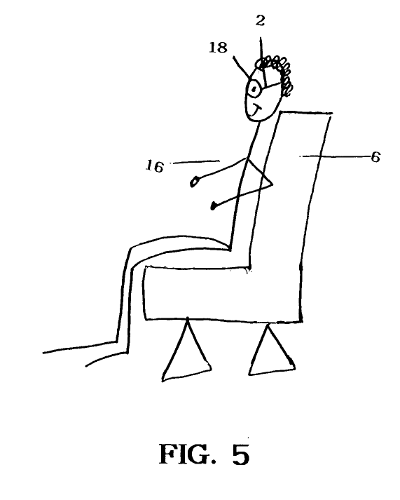

FIG. 6 is a fifth alternative embodiment to the present invention.

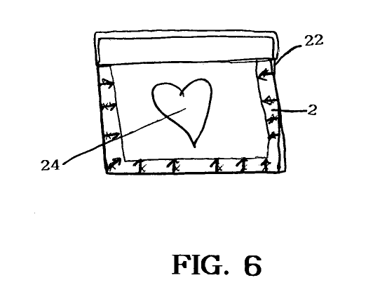

### DETAILED DESCRIPTION OF THE INVENTION

One embodiment of the invention is installed with the plane's interior. Integral with the aisle and seating foot areas is placed a magnetic sheet which may be of a ferrite, rubberized, flexible or rigid material having a bipolar magnetic field characteristic such that a north magnetic field is facing the passenger's 16 feet. Direct current electro-magnetic wiring may also be used, laid out similarly in a large single circuit or multiple individual circuits, allowing each passenger 16 to elect whether or not to have a magnetic field present.

Another embodiment consists of individual sized magnetic mats distributed to passengers for local placement proximate their feet.

A complete Jet Lag deterrent kit available from the airline or available to individual consumers for use during air line travel may consist of: 1) a magnetic 2 mat 4, magnetic soled slippers or magnetic shoe inserts 20 or 2) individual magnets for application proximate the user's body 16 e.g. in pockets, wristbands, headbands, earphones and/or eyeglasses 18.

The magnetic mat 4 can be used on the floor 14 of place, the seat 6 and/or the seat back 10, or in the rear of the seat in front, such as in the pocket 12. The magnet 2 may be integral or can be provided to the passenger. The magnet maybe a permanent magnet or an electromagnet. 3) Nutritional supplements including vitamins and hydration assisting elements and herbs and/or liquid solutions which may include or consist of magnetized water.

The method of the invention is to provide a replacement for the earth's magnetic field proximate the body thereby creating exposure to a magnetic north field as a substitution for the exposure naturally occurring on the earth's surface. Higher than normal magnetic fields may be used to combat the naturally occurring stresses of air flight. Nutritional and fluid supplements may be used to combat dehydration and degeneration of blood oxygen uptake rates.

For protection of human tissue, transported or stored prior to transplantation, an insulated container 22 with a magnetic sheet. The magnet 2 having a bipolar characteristic such that a north magnetic field faces the human tissue, may be used. The magnet 2 may be built into the structure of the container 22 along the bottom and/or side walls or be a sealed insert for placement into the insulated container 22 along with the human tissue.

1. A method for reducing jet lag comprising the steps of:
orienting a magnet such that a magnetic north field faces a passenger on an air plane,
locating the magnet proximate to the passengers body, and
applying a magnetic north field of at about the same gauss as the earth's magnetic filed to the passenger during at least a portion of a flight.

2. The method of claim 1 wherein the magnet is a permanent magnet.

3. The method of claim 2 wherein the magnet is a magnetic sheet.

4. The method of claim 3 wherein the magnetic sheet is formed as a foot mat and further comprising the steps of placing the foot mat on the floor and placing the passenger's feet on the mat.

5. The method of claim 4 wherein the magnetic sheet is integral with the floor and comprising the additional step of placing the passenger's feet on the floor.

6. The method of claim 3 further comprising the steps of placing the magnetic sheet on a seat, a seat back or the seat and the seat back and sitting on the magnetic sheet.

7. The method of claim 6 wherein the magnetic sheet is integral with the seat.

8. The method of claim 3 further comprising the step of placing the magnetic sheet in a back of a first seat and sitting the passenger in a second seat located behind the first seat.

9. The method of claim 8 wherein the magnetic sheet is integral with the first seat.

10. The method of claim 2 wherein the magnet is located in socks, slippers or shoes and comprising the additional steps of placing the passenger's feet in the socks, slippers or shoes with the magnet.

11. The method of claim 2 wherein the magnet comprises a plurality of individual magnets and the individual magnets are placed proximate to the user's body.

12. The method of claim 11 wherein the individual magnets are located in wristbands, headbands, eyeglasses, jewelry and/or pockets of the passenger.

13. The method of claim 2 wherein the magnet is integral to the plane.

14. The method of claim 13 wherein the magnet is placed along the aisle of the plane.

15. The method of claim 1 wherein the magnet is an electromagnet.

16. The method of claim 15 further comprising the additional step of applying the magnetic field to the passenger only when requested by the passenger.

17. The method of claim 16 further comprising the step of deactivating the magnetic field applied to the passenger upon request from the passenger.

18. The method of claim 1 wherein a magnetic field with a gauss higher than the earth's magnetic field is applied.

19. A method of protecting human tissue comprising the step of placing the tissue in a container with a magnetic north field facing toward the tissue.
